(19) United States
(12) Patent Application Publication
(10) Pub. No.: US 2019/0368013 A1
(43) Pub. Date: Dec. 5, 2019

(54) Fe-Ni Nanocomposite Alloys

(71) Applicant: Carnegie Mellon University, Pittsburg, PA (US)

(72) Inventors: Natan Aronhime, Pittsburgh, PA (US); Michael E. McHenry, Pittsburgh, PA (US); Vladimir Keylin, Pittsburgh, PA (US)

(21) Appl. No.: 16/434,869

(22) Filed: Jun. 7, 2019

Related U.S. Application Data
(63) Continuation-in-part of application No. PCT/US2017/065396, filed on Dec. 8, 2017.
(60) Provisional application No. 62/497,935, filed on Dec. 8, 2016.

(51) Int. Cl. C22C 38/12; C22C 38/08; C22C 38/02; B32B 15/01; H02K 1/02; H01F 1/147

(52) U.S. Cl. CPC C22C 38/12; C22C 38/08; C22C 38/02; B32B 15/011; C22C 2200/04; H01F 1/14733; B32B 2457/00; C22C 2202/02; H02K 1/02

(57) ABSTRACT

A nanocomposite comprising crystalline grains in an amorphous matrix, the crystalline grains comprising an iron (Fe)-nickel (Ni) compound and being separated from one another by the amorphous matrix; and one or more barriers between the crystalline grains and the amorphous matrix, the barriers being configured to inhibit growth of the crystalline grains during forming of the crystalline grains, a barrier of the one or more barriers being between a crystalline grain and the amorphous matrix; wherein the amorphous matrix comprises an increased resistivity relative to a resistivity of the crystalline grains; and wherein the amorphous matrix is configured to reduce losses of the crystalline grains caused by a change in a magnetic field applied to the crystalline grains relative to losses of the crystalline grains that occur without the amorphous matrix.

### CLAIM OF PRIORITY

This application claims priority under 35 U.S.C. § 120 as a bypass continuation-in-part of Application Serial No. PCT/US2017/065396, filed on Dec. 8, 2017, which claims priority under 35 U.S.C. § 119(e) to U.S. Patent Application Ser. No. 62/497,935, filed on Dec. 8, 2017, the entire contents of each of which are hereby incorporated by reference.

### GOVERNMENT RIGHTS

This invention was made with government support under the National Science Foundation No. 19346.1.2001271, and with support from the Army Research Laboratory 33164.1.1130173. The government has certain rights in this invention.

### BACKGROUND

This disclosure relates generally to nanocomposite alloys. More specifically, this disclosure relates to Fe—Ni nanocomposite alloys.

Materials exhibiting ferromagnetism are those for which the electron spin dipole moments are ordered in the absence of magnetic field over a volume called a magnetic domain below a temperature called the Curie temperature, T_{c}. In an applied field of sufficient strength, a magnetically saturated material has a single magnetic domain encompassing the sample volume. In zero field it is energetically favorable to have multiple domains to minimize demagnetization fields. When an external field is applied, there are two ways with which the domains can align with the direction of the field: (1) domain growth or (2) domain rotation. In domain growth, domains that are already aligned in the field direction expand at the expense of their neighbors by domain wall movement. Domain rotation is when instead of wall motion, individual atomic moments rotate to align in an applied field.

Magnetic materials are broadly split into two groups, soft magnets and hard/permanent magnets. The two groups are differentiated by their coercivities, with soft magnets having much lower values and permanent magnets difficult to demagnetize. Other important magnetic parameters are saturation magnetization and permeability. Saturation magnetization is the magnitude of the magnetization of a single magnetic domain, and permeability relates the strength of the external field to the magnitude of the induced internal field. Developing the correct balance of these properties for various applications drives research in magnetic materials.

Michael Faraday first demonstrated the law of induction using an Fe core. As the electricity industry developed and accepted AC currents, Fe cores proved to be too lossy due to their low resistivity, which led to high classical eddy current losses. For this reason, silicon steels have been studied since the 1880's and had market dominance by the 1930's. Silicon steels are still the industry standard for high voltage AC power transformers. For more specialized applications, higher inductions are required which led to the development of Fe—Co alloys that have found use in military applications and where cost is less of a concern. Fe—Co alloys have the highest inductions of transition metal alloys. This can be understood in relation to the Slater-Pauling curve. Other applications, such as sensors and motors, require higher permeabilities than that of Si-steel. For these applications Fe—Ni alloys, permalloys, were developed.

### SUMMARY

The nanocomposite includes crystalline grains in an amorphous matrix, the crystalline grains including an iron (Fe)-nickel (Ni) compound and being separated from one another by the amorphous matrix; and one or more barriers between the crystalline grains and the amorphous matrix, the barriers being configured to inhibit growth of the crystalline grains during forming of the crystalline grains, a barrier of the one or more barriers being between a crystalline grain and the amorphous matrix; where the amorphous matrix comprises an increased resistivity relative to a resistivity of the crystalline grains; and where the amorphous matrix is configured to reduce losses of the crystalline grains caused by a change in a magnetic field applied to the crystalline grains relative to losses of the crystalline grains that occur without the amorphous matrix.

Additionally, this document describes a range of compositions in the (Fe₇₀Ni₃₀)₈₀(B—Si—Nb)₂₀ system shown to have good glass forming ability (GFA) by models based on Thermocalc simulations and experimental validation. In particular, a range from B=14-18%, Si=0-7%, and Nb=0-6% have excellent GFA and are preferred embodiments of the subject application. Additionally, some of these alloys have a large ΔTxg=(Tx−Tg), where Tx corresponds to the primary crystallization temperature and Tg corresponds to the glass transition temperature of the amorphous phase, which will allow them to be processed by various thermomechanical means at elevated temperatures including stamping, rolling and die forming. Example embodiments of advanced manufacturing processes uniquely compatible with these alloys include (1) hot rolling at temperatures above Tg of the amorphous precursors to allow for thinning prior to ribbon nanocrystallization, (2) hot stamping of ribbons above Tg of the amorphous precursors to form laminates of desired geometry, (3) inductive rolling where eddy currents within the ribbons are used to create the heating source through RF excitation of the rollers, and even (4) hot rolling in conjunction with nanocrystallization for alloy compositions where the intergranular amorphous phase is engineered to retain a low T_{g} as the crystallization process proceeds. The large ΔT_{xg} is still seen after partial crystallization of the amorphous precursor, allowing these alloys to be thermomechanically processed even after nanocrystallization.

In some implementations, the crystalline grains comprise a Fe—Ni base that is meta-stable, face-center, and cubic. In some implementations, the Fe—Ni base comprises γ-FeNi nanocrystals.

In some implementations, the barrier comprises niobium (Nb); and where the amorphous matrix comprises boron (B) and silicon (Si) that together are configured to enable glass-forming ability of the amorphous matrix. In some implementations, the nanocomposite includes a copper (Cu) nucleation agent configured to increase nucleation of the crystalline grains during a forming process relative to the nucleation of the crystalline grains during a forming process without the copper nucleation agent, and where the crystalline grains are reduced by more than 10% as a result of the increased nucleation.

In some implementations, a crystalline grain comprises an average diameter between 5-20 nm.

In some implementations, the nanocomposite forms a ribbon that is between 15-30 μm thick. In some implementations, the nanocomposite comprises a magnetic anisotropy that is longitudinal along the ribbon.

In some implementations, the nanocomposite includes 50 atomic % or less of one or more metals including boron (B), carbon (C), phosphorous (P), silicon (Si), chromium (Cr), tantalum (Ta), niobium (Nb), vanadium (V), copper (Cu), aluminum (Al), molybdenum (Mo), manganese (Mn), tungsten (W), and zirconium (Zr). The nanocomposite comprises 30 atomic % or less of cobalt (Co). In some implementations, the nanocomposite includes approximately 30 atomic % of Ni. In some implementations, a resistivity of the crystalline grains is approximately 100 μΩ-cm and where a resistivity of the amorphous matrix is approximately 150 μΩ-cm. In some implementations, the amorphous matrix is annealed to enable a superplastic response of the nanocomposite. In some implementations, the crystalline grains in the amorphous matrix and the diffusion barriers comprise a strain-annealed structure that is tuned to a relative magnetic permeability above 10,000. The change in a magnetic field applied to the crystalline grains occurs at a frequency between 400 Hz and 5 kHz. In some implementations, the losses comprise eddy current losses.

In some implementations, a rotor includes one or more composite layers each including: γ-FeNi nanocrystals in an amorphous matrix, the γ-FeNi nanocrystals having an average resistivity of less than 100 μΩ-cm and the amorphous matrix having a resistivity greater than 100 μΩ-cm; and one or more boron diffusion barriers each between one or more of the γ-FeNi nanocrystals the amorphous matrix, each of the one or more diffusion barriers being configured to inhibit diffusional growth of the γ-FeNi nanocrystals during forming of the γ-FeNi nanocrystals; where the γ-FeNi nanocrystals are approximately 70 atomic % Ni; where an average diameter of the γ-FeNi nanocrystals is between 5 nm-30 nm; and where the one or more composite layers are each less than approximately 25 μm thick.

In some implementations, the composite layers each are strain-annealed composites including relative magnetic permeabilities above 10,000. In some implementations, the composite layers each further comprise copper.

In some implementations, an electric motor includes a rotor; and a stator configured to drive the rotor, the stator including a number of laminations that are less than 30 μm thick, each lamination including: crystalline grains in an amorphous matrix, the crystalline grains including an iron (Fe)-nickel (Ni) compound and being separated from one another by the amorphous matrix; and one or more barriers between the crystalline grains and the amorphous matrix, the barriers being configured to inhibit growth of the crystalline grains during forming of the crystalline grains, a barrier of the one or more barriers being between a crystalline grain and the amorphous matrix; where the rotor is configured to operate at frequencies above 400 Hz.

In some implementations, a method of producing an amorphous precursor to a nanocomposite via heat treatment with and without applied stress, resulting in unique metastable multiphase microstructure.

The applied stress during annealing induces an anisotropy that is dependent on the chemistry. The induced anisotropy in Fe-rich alloys is along the ribbon axis and yield an increase in permeability. In Ni-rich alloys, the induced anisotropy is transverse to the ribbon axis resulting on lower permeability. By further alloying additions, resistivity can be increased by approximately 40% without significant effects on the magnetic properties. Adding Cu alters the crystallization kinetics and refines the microstructure, yielding smaller grains. Using different glass formers alters the formability, and affects the mechanical properties of the nanocomposite. Uses of these alloys include high switching frequency electric motors. For example, axial motors with rare earth free permanent magnets. In addition, motor designs that utilize only soft magnetic materials, such as switched reluctance motors.

In some implementations, the nanocomposites are materials in the Ni 20%-80% range. The microstructure is controlled by melt-spinning and various post-processing methods such as strain-annealing, allowing for tuning of the properties to meet the demands of diverse applications.

The nanocomposite described below includes several advantages. Certain alloy compositions described below have attractive superplastic response for allowing more practical stamping of useful shapes. In Fe-rich compositions, strain annealing can induce anisotropies along the ribbon direction, thereby increasing the permeability along the ribbon direction. The crystallization products are γ-FeNi, which in Fe-rich compositions is metastable, in addition to α-FeNi in Fe-rich compositions. The nanocomposites described below improve the efficiency of motors operating at high rotational speeds.

The nanocomposites described below are useful for high frequency applications. For example, laminated silicon-steels are traditionally used in motors. However, laminated silicon-steels become inefficient at high frequencies because of traditional and anomalous eddy current losses. Using higher frequencies is attractive though due the higher potential power output (motor power is torque times rotational frequency). The nanocomposites described below have reduced losses during high-frequency switching of the magnetic field. This enables higher frequencies to be applied to a motor stator comprising the nanocomposite without losing power efficiency and without requiring a larger motor. Higher frequencies would allow for reduced size and mass of inductive components. Cost savings may arise from the reduction of motor size. Many motor designs use permanent magnets to create or direct magnetic flux. Because motor size can be reduced with high frequency, significantly, less rare-earth material can be used for devices that utilize rare-earth permanent magnets. This is attractive due to the cost and the sourcing concerns of rare-earth metals.

Details of one or more implementations are set forth in the accompanying drawings and the description below. Other features, objects, and advantages will be apparent from the description, the drawings, and the claims.

### BRIEF DESCRIPTION OF THE DRAWINGS

FIG. 1 shows an illustration of crystallites surrounded by diffusion barriers in an amorphous matrix.

FIGS. 2A-2B show examples of Fe—Ni alloys.

FIG. 3 shows a comparison of motors.

FIG. 4 displays a graph of losses during magnetic switching cycles.

FIG. 5 is an illustration of T₀ diagram construction for a binary alloy.

FIG. 6 shows various amorphous alloy matrices.

FIG. 7 shows Fe—Ni binary phase diagram.

FIG. 8 shows saturation magnetization as a function of composition in as-cast alloys.

FIG. 9 is an illustration of x-ray diffraction.

FIG. 10 shows T_{g}, primary, and secondary crystallization temperatures as a function of composition.

FIG. 11 shows M vs. H data for the Fe₇₀Ni₃₀ as-cast and strain annealed.

FIG. 12 displays graphs each showing HTXRD for a Fe-rich Fe—Ni alloy.

FIGS. 13A-13B are examples of motors.

FIGS. 14A-14B show simulation results for glass-forming ability (GFA) for various material compositions.

FIG. 15 shows an example of a hot rolling mill system for processing one or more of the alloy compositions.

FIG. 16 shows an example of a roll-bonding scheme for applying heat to alloy compositions.

FIG. 17 shows a graph including variation in glass transition temperature T_{g} with respect to changes in annealing temperatures.

### DETAILED DESCRIPTION

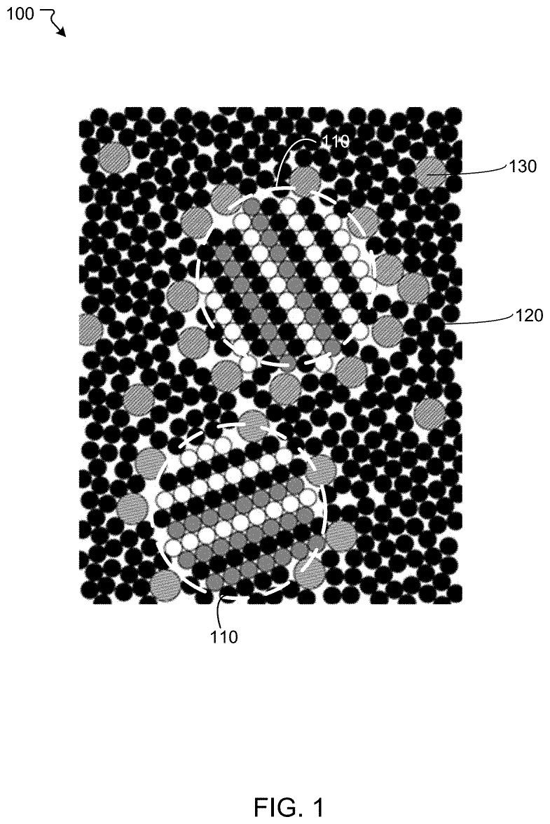

FIG. 1 shows a nanocomposite material 100 including one or more crystalline grains 110, an amorphous matrix 120, and a diffusion barrier 130. The crystalline grains 110 are formed by a crystallization process, described in further detail below. Generally, the crystalline grains 110 (also known as crystallites) each include a small or microscopic crystal which forms, for example, during the cooling metallic materials such as Fe—Ni alloys. The crystalline grains 110 generally include a regular or near-regular lattice of atoms, as seen in FIG. 1. Grain boundaries are interfaces where the crystalline grains meet other materials, such as the amorphous matrix. Generally, the crystalline grains 110 do not touch one another, but are in (e.g., embedded in) the amorphous matrix, which includes a relatively high resistivity material between the relatively low resistivity crystalline grains. The crystalline grains 110 have an average diameter of between 5-30 nm, and are formed of Fe—Ni alloys. In some implementations, the nanocomposite includes materials in the Ni 20%-80% range. The crystalline grains 110 can include average sizes of between 5-20 nm embedded in the amorphous matrix 120. In some implementations, the crystalline grains 110 include Fe—Ni alloys. The properties (e.g., magnetic or resistivity properties) of the crystalline grains 110 can be tuned by adding additional materials. Other metals such as cobalt or copper, are included in the crystalline grains 110 as described in further detail below. In some implementations, crystalline grains 110 formed of varying alloys, such as various Fe—Ni alloys, are used to tune the resistivity, permeability, or other properties of the nanocomposite. In some implementations, the crystalline grains 110 are each formed from the same materials or alloys for the nanocomposite 100. In some implementations, the crystalline grains 110 vary in composition throughout the nanocomposite 100.

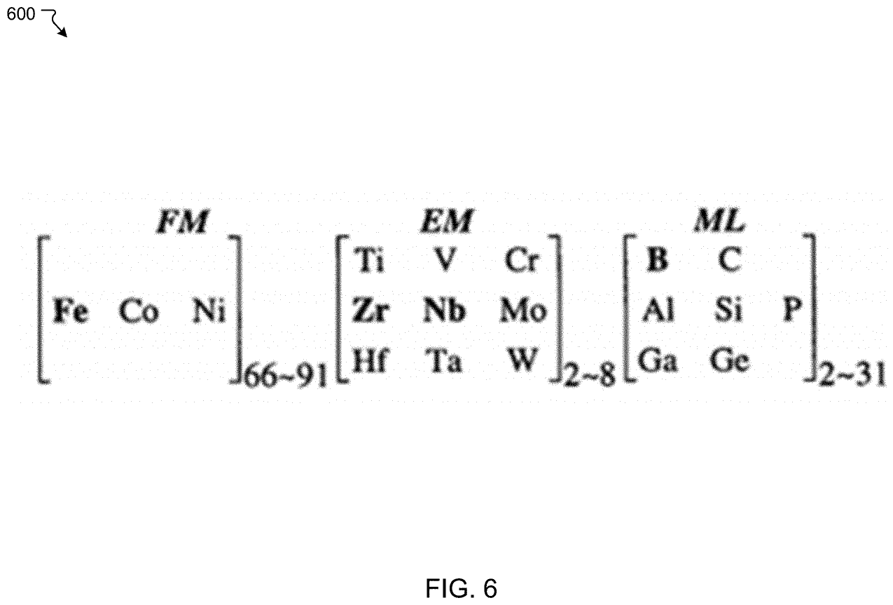

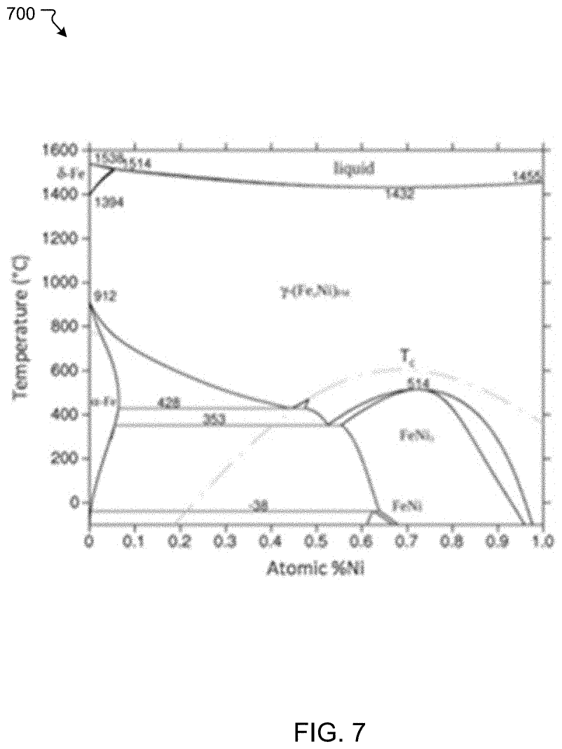

Generally, the amorphous matrix 120 includes a metal or metalloid that forms non-crystalline solid, such as a solid that lacks the long-range order that is characteristic of a crystal. The amorphous matrix 120 has a relatively high resistivity compared to the crystalline grains 110. The crystalline grains 110 are in the amorphous matrix 120 and are generally separated from each other by the amorphous matrix. The resistivity, relative magnetic permeability, and other properties of the amorphous matrix 120 can be tuned by adjusting the composition of the amorphous matrix. In some implementations, the amorphous matrix 120 includes one or more of the metalloids or early transition metals described in relation to FIG. 6. Generally, the average spacing between the crystalline grains 110 provided by the amorphous matrix 120 is less than the average diameter of the crystalline grains (e.g., <10-15 nm).

Generally, the diffusion barrier 130 is a metal or metalloid that is configured to inhibit the growth of crystalline grains 110 during annealing or other forming processes. Including the material of the diffusion barrier 130 enables tuning of the sizes of the crystalline grains 110 and thus the resistivity, relative magnetic permeability, etc. of the nanocomposite 100. In some implementations, the diffusion barrier 130 prevents impingement of the crystalline grains 110 on each other.

Crystallization is a phase transformation that is controlled by nucleation and growth kinetics. The function of the glass formers is to control the crystallization kinetics. From Johnson-Mehl-Avrami-Kolmogorov (JMAK) kinetics, the volume fraction transformed (X) can be represented as a function of temperature (T) and time (t) in a TTT-diagram. The JMAK equation is:

X=1−exp(−(k(t−tᵢ))ⁿ) (6)

where tᵢ is the incubation period, n varies between 1 and 4, and k is the rate constant and can be expressed as:

$$k = {k}_{0} exp ( \frac{- Q}{{k}_{B} T} ) \qquad ( 7 )$$

From determining X at various temperatures, k and Q can be calculated. JMAK kinetics is built off the following 3 assumptions that are not true for nanocomposite systems, which include that 1) growth stops when precipitates impinge on one another; 2) 100% of the volume is transformed; and 3) nucleation is homogenous.

However, for nanocrystallization, the early transition metal atoms are expelled from the crystalline phase and form a diffusion barrier around the crystals slowing further growth. This invalidates assumptions 1 and 2, requiring soft impingement corrections to be employed. There are several viable methods for determining X. If the T_{C} of the amorphous phase is lower than the T_{C} of the crystallites, crystallization can be seen with magnetization data. The sample's magnetization will initially only be from the amorphous phase. The magnetization will decrease as the amorphous phases' T_{C} is approached. When primary crystallization occurs, the magnetization will increase. While cooling, the remaining amorphous phase will again contribute to the total magnetization. By comparing the initial amorphous phase, the crystalline, and the remnant amorphous magnetization, the volume fraction of the crystallites can be determined.

Another method to determine the volume fraction of crystallites is to use XRD. By fitting Gaussian curves to the peaks present in the diffraction pattern, the peak areas can be determined. Comparing the amorphous peak area to the crystalline peak area, the relative fractions can be determined. This is especially doable utilizing synchrotron radiation because the data can have high time resolution.

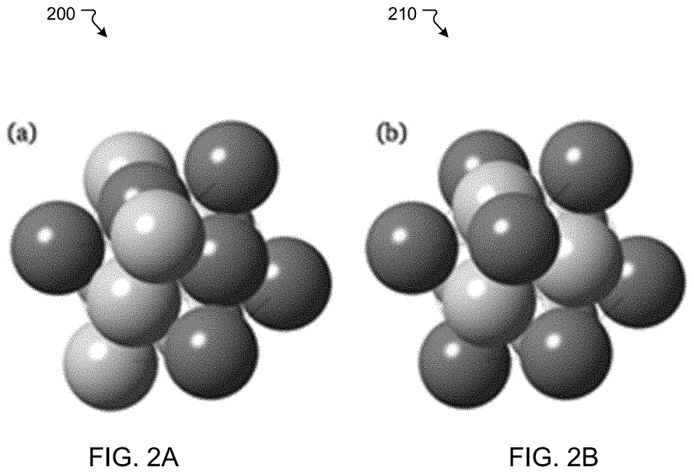

While the primary crystallization event from an amorphous material is beneficial from a devices standpoint, secondary crystallization is deleterious for magnetic properties. In secondary crystallization, the metalloid and glass forming elements form crystalline intermetallic phases with the transition metals. Due to their negative effects in allowing fast grain growth, it is important to determine the secondary crystallization kinetics in order that it can be prevented during device use. In some implementations, the crystalline grains 110 of FIG. 1 include meta-stable face-center cubic Fe—Ni bases, such as shown in FIGS. 2A-2B. FIG. 2A shows alloy 200 including disordered γ-FeNi (Ni in white, Fe in gray). FIG. 2B shows alloy 210 including L12 FeNi₃.

Phase Diagram:

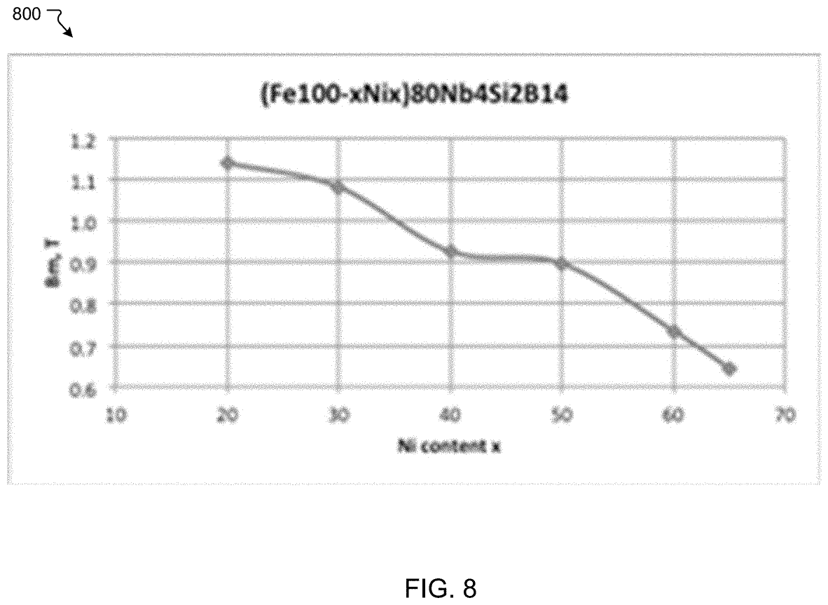

The binary Fe—Ni phase diagram can be seen in FIGS. 8a-b. The phase boundaries are where the Gibbs free energies of the two phases are equal. However, due to the glass formers in the alloy, this system is not in equilibrium. As such, when the system crystallizes from the amorphous as-cast structure, one cannot be sure that the resulting crystallites are FeNi₃ or γ-FeNi without XRD and possibly TEM evidence of superlattice reflections, as was also the case in near equiatomic FeCo systems.

In addition to the equilibrium phases, FIG. 8B plots the T_{C} for the γ-FeNi phase and the α-Fe phase as a function of composition. For traditional motor applications, the region near 70% Ni is of interest due to the high T_{C}. In addition, the T_{C} is even higher if Ni₃Fe is crystallized instead of the γ-phase. Even at the Fe-rich side of the diagram, the T_{C} may be high enough for motor applications.

Fe—Ni nanocomposites allow for a wide range of compositions. Rather than α-Fe nanocrystals, metastable γ-FeNi nanocrystals can be used, even for Fe-rich compositions. In Ni-rich Fe—Ni nanocomposites, crystallization develops either γ-FeNi, or an ordered L1₂ (FIG. 1) structure with Ni₃Fe.

Several Fe—Ni alloys have attractive properties for applications. For example, the 50-50 Fe—Ni alloy has the highest saturation magnetization. For Ni-rich alloys, 78% Ni permalloys are important due to their zero-magnetostriction coefficient and high (relative) permeability of approximately 100,000. Since not all properties can be optimized at once, the composition is typically chosen with particular device applications in view. Fe-rich Fe—Ni alloys have been studied recently for use in magnetocaloric cooling applications due to near room temperature T_{C}'s.

The nanocomposite 100 includes Fe—Ni based metal amorphous nanocomposite (MANC) materials for motors in the 20%-80% Ni range of compositions. Interestingly, there is evidence of asperomagnetism in certain Fe-rich alloys. Modifying the glass former composition will also impact the ease of casting, and the mechanical properties. Of the early transition elements, Nb typically allows to cast in air, while Hf and Zr typically do not. Changing the metalloid mixture can also improve formability, and may allow tuning of the magnetostrictive coefficients.

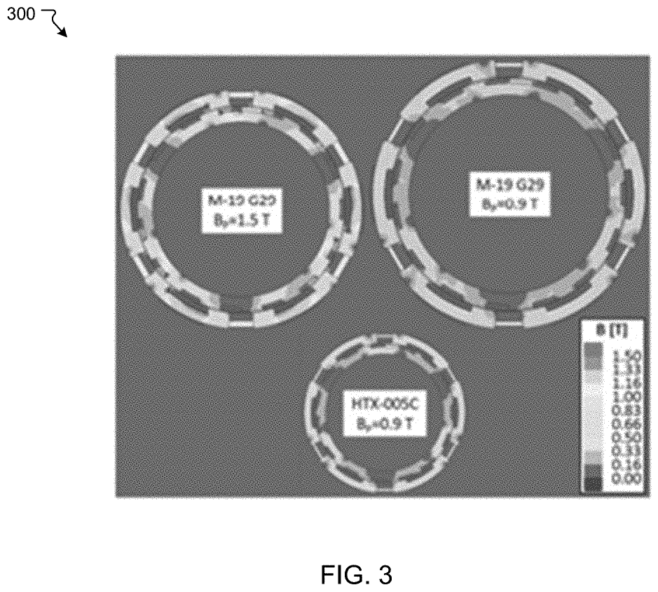

The principal of electric motor operation can be discussed with reference to eq. 1 which relates Faraday's Law of Induction to the voltage response of an ideal core driven by an AC current:

$$V = \frac{- μ {N}^{2} A}{l} {I}_{0} ωcos ( ω t ) \qquad ( 1 )$$

where ω=2πf and f is the frequency. Keeping all other variable constant, if f is increased, then A can be decreased for a constant voltage. This means the device size can be reduced by increasing the frequency. However, increasing the frequency increases the losses that are incurred. Therefore, if smaller devices are desired, materials with reduced losses at high frequencies must be engineered. Motors are measured by their power density, i.e. the amount of power output by unit volume of motor. FIG. 3 shows three rotors designed to have equivalent power outputs. The two at top are made of Si-steel, while the bottom rotor is made of a HITPERM alloy. As can be seen, using the HITPERM alloy and using larger magnetizations allow smaller rotor design yielding a higher power density. Preliminary designs in COMSOL Multiphysics suggest motor size can be reduced almost 50% by switching from Si-steel running at 60 Hz to an Fe—Ni MANC running at 1 kHz. FIG. 3 shows a comparison 300 of Si-steel rotors (top) to a HITPERM alloy (bottom) with the same power output.

The nanocomposite described herein includes materials to improve the efficiency of motors, operating at high rotational speeds, by using Fe—Ni nanocomposites that are more economical than Co—Fe counterparts for motor applications. The microstructure is controlled by melt-spinning and various post-processing methods such as strain-annealing, described in further detail below. By this process, the properties (e.g., magnetic permeability, induced anisotropy, crystalline grain size, etc.) of various alloys are tuned to meet the demands of diverse motor applications. For example, in Fe-rich compositions, strain annealing induces anisotropies along the ribbon direction. Furthermore, certain alloy compositions, described below, have attractive superplastic response for allowing more practical stamping of useful shapes for motor laminates.

Losses:

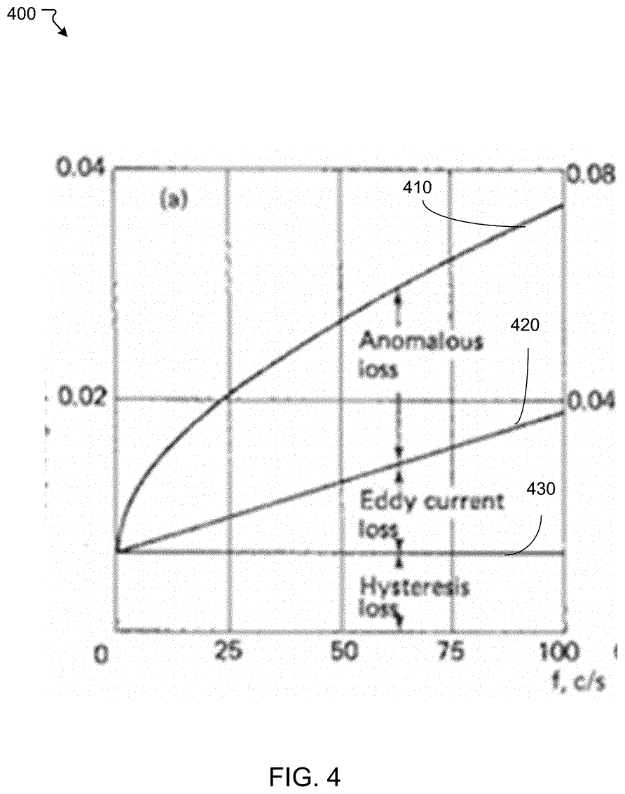

FIG. 4 shows a graph 400 representing three sources of losses as a function of frequency. AC losses in a magnetic material can be separated into those arising from (1) magnetic hysteresis, (2) conventional eddy currents and (3) anomalous eddy currents. Each of these losses has a different frequency dependence. Hysteresis losses relate to the area inside the hysteresis loop of a material which is the energy/volume lost over one magnetic cycle. Since it is a constant amount per cycle, the total power lost is linear with time. Hysteresis losses can be decreased if the coercivity (H_{c}) of the materials is lowered. This is one reason why using a nanocomposite material is beneficial. Reducing crystallite size below a certain amount significantly lowers H_{c}, thereby lowering losses.

Classical eddy current losses relate to the fact that an AC current produces and alternating magnetic field, which induces eddy currents in the material. These currents give rise to I²R power losses that heat the material. Classical eddy current losses are described by eq. 2:

Pₑ=bf²B² (2)

with the coefficient b given by eq. 3

$$b = \frac{{( π \cdot t )}^{2}}{ρ} \qquad ( 3 )$$

where t is the thickness and ρ is the resistivity. It follows that to minimize classical eddy currents, thin cross sections and high resistivity are desired. Thin cross sections are obtained through melt-spinning the alloy. The relevant variables are wheel speed, casting temperature, ejection pressure, and nozzle-wheel gap distance. Standard silicon-steels used in motors have lamination thickness near 0.6 mm. By using a ribbon that is 25 μm thick, eddy losses are reduced by approximately two orders of magnitude. The nanocomposite 100 enables ribbons that are approximately 15-30 μm to be produced. Hysteresis loss and eddy current loss are often expressed in terms of the Steinmetz equation:

P=kf^{α}Bₘ^{β} (4)

with P as power loss, and k, α, and β are empirical fits to data.

To model the resistivity of a nanocomposite, it is fruitful to consider three phases: the crystalline, amorphous, and a shell phase comprised primarily of glass formers and growth inhibitor atoms. A benefit of an amorphous structure is, since it has higher resistivity than a chemically identical crystalline phase, that it increases the resistivity of the nanocomposite, thereby lowering the classical eddy current losses. Of the three, the crystalline phase has the lowest resistivity, and because the shell has the highest concentration of glass formers, it has the highest resistivity. For example, the as-cast amorphous ribbon nanocomposite has a resistivity of approximately 150 μΩ-cm. The crystalline resistivity is approximately 100 μΩ-cm. Without the shell, it is assumed that the path of least resistance would be to maximize the distance travelled in crystallite in relation to amorphous matrix. However, the high resistivity shell complicates this. From previous modeling, it is known that to maximize resistivity, each of small crystalline grain sizes (e.g., <10-15 nm), high glass former concentration in the shell, and a thick shell around the crystals are desired.

The third source of loss is anomalous eddy currents. Anomalous losses are due to domain wall movement when the magnetization of the material is switched. Domain wall movement is reduced if a magnetic anisotropy is induced such that the magnetic domains are aligned transverse to the ribbon direction in the absence of a magnetic field.

Phase Relations in the Fe—Ni Pseudobinary System:

Glass Formation:

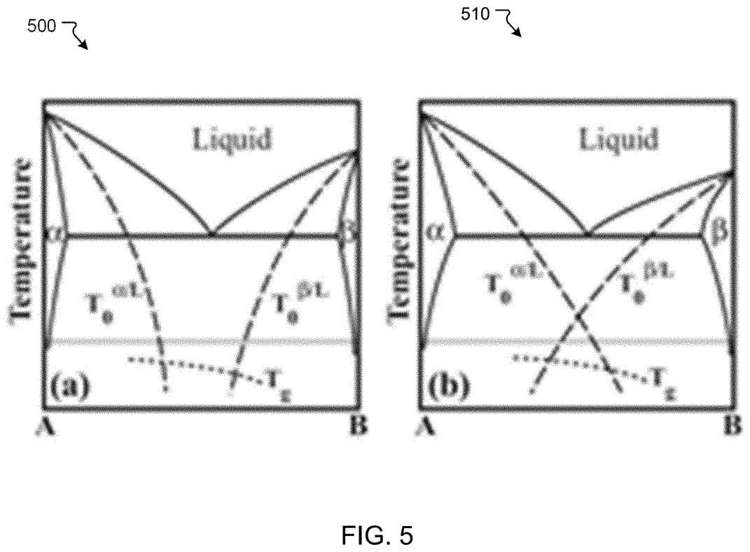

Before the Fe—Ni pseudobinary system is addressed, glass formability and nanocrystallization kinetics are examined. The glass-forming ability (GFA) of a material explains the suppression of nucleation and growth of the stable crystalline phase. This involves preventing the elements in the liquid from partitioning into the crystalline phase/s. A material's GFA is related to its reduced glass-forming temperature (T_{rg}), which is expressed by:

$${T}_{rg} = \frac{{T}_{g}}{{T}_{L}} \qquad ( 5 )$$

where T_{g} is the glass transition temperature and TL is the liquidus temperature. Below T_{g}, the structure is frozen, but above T_{g}, the material is capable of viscous flow. For ease of glass formation, T_{g} should be maximized and TL should be minimized. Glass formation thermodynamics is illustrated in the T₀ diagrams 500, 510 in FIG. 5. The T₀ curve describes all points where the liquid and solid phase free energies are equal. For compositions between the T₀ curves, the liquid can lower a free energy only by diffusion into the α and β phase. Outside the T₀ curves, the liquid can form solid crystals without diffusion. Within the T₀ curves, if the melt is quenched below the T_{g} rapidly enough, diffusion cannot occur and a liquid atomic structure is frozen.

Suzuki has created an amorphous alloy matrix that can be used initially to develop nanocrystalline alloys. The matrix is a graphical representation of Inoue's rules to form a magnetic glass. The glass should have 3 components that have significantly different atomic radii and have a negative heat of mixing.

Various combinations of alloys can be seen in the matrices 600 of FIG. 6. In FIG. 6, FM is ferromagnetic late transition metal elements, EM is early transition metals and ML is metalloids. Nb is a common EM used as a diffusional growth inhibitor because it allows casting in atmosphere, which is important for industrial scaling. The diffusion barrier limits primary crystallization, so the resulting crystallites are small. Boron is the preferred metalloid due having practically zero solubility in the FM crystals formed during primary crystallization, and the T_{C} is increased in the amorphous matrix by the resulting B-enrichment. Silicon is required in conjunction with boron to ensure glass forming ability. The use of other transition metals and metalloids in different amounts is expected to change glass formability and the mechanical properties of the resulting alloy. The nanocomposite can include 50 atomic % or less of one or more metals comprising boron (B), carbon (C), phosphorous (P), silicon (Si), chromium (Cr), tantalum (Ta), niobium (Nb), vanadium (V), copper (Cu), aluminum (Al), molybdenum (Mo), manganese (Mn), tungsten (W), and zirconium (Zr). In some implementations, the nanocomposite includes 30 atomic % or less of cobalt (Co).

Example Fabrication and Experimental Tools:

The materials of the nanocomposite follow the general chemical formula of (FeₓNi₁₋ₓ).₈₀Nb₄Si₂B₁₄. x will be varied over a large range. The materials are all arc-melted several times in a controlled atmosphere from pure elements to obtain chemical homogeneity. The ingots are then melt-spun in a controlled atmosphere. Casting condition such as wheel speed, ejection temperature, ejection pressure, and nozzle-wheel distance are all controlled so as to produce amorphous ribbons. Amorphousness is first checked by a simple bend test. Typically, if the sample is not amorphous, it will be very brittle and will break if bent. If it passes the bend test, run x-ray diffraction (XRD) will be run to ensure the cast is amorphous.

Once an amorphous ribbon is produced, differential scanning calorimetry (DSC) measurements are used to determine primary and secondary crystallization temperatures, and if possible, the glass transition temperature as well. A DSC measures the heat supplied to a sample and a reference. The reference and sample are maintained at equal temperatures. During a transition, the amount of heat required to maintain equivalent temperatures will either increase or decrease depending whether the transition is endothermic or exothermic. By measuring the change in heat supply rate, transformation temperatures can be deduced.

By determining the transformation temperatures, the activation energy of crystallization can be calculated. The amorphous phase is metastable, and a certain amount of energy is required to nucleate a crystalline phase. This results in an activation energy, Q, that is present in eq. (6). The most convenient way to determine the activation energy for crystallization is by using Kissinger kinetics. The Kissinger equation can be expressed as:

$$ln ( \frac{α}{{T}_{x}^{2}} ) = - \frac{{Q}_{K}}{{RT}_{x}} + c \qquad ( 8 )$$

where a is the heating rate, Tₓ is the crystallization temperature, and Q_{K} is the activation energy (so as not to confuse activation energies derived using the Kissinger equation and with JMAK kinetics.) Q_{K} is then the slope of line plotting the left-hand side equation (7) against 1/Tₓ. One energy barrier that contributes to Q is the energy required to nucleate a critical nucleus size. Below a critical size, any formed crystal will be unstable, and the free energy will be reduced if the crystal dissolves in the liquid due to the solid-liquid interfacial energy. Once nuclei are formed that are larger than the critical size, they will grow during crystallization. During primary crystallization, growth is a diffusional process that is temperature dependent and presents another contribution to Q. Primary crystallization is thought to be controlled by volume diffusion, which has parabolic growth with time, at least until soft impingement occurs. During primary crystallization, the amorphous matrix becomes enriched with the glass-forming elements. Other contributors to Q are the volume free energy reduction from crystallization, and the misfit strain energy.

Since the magnetic properties of the materials are of interest, vibrating sample magnetometry (VSM) is used to determine M vs. H loops, and M vs. T curves at the relevant fields and temperatures respectively. Operation of a VSM is explained through application of Faraday's Law of induction. A magnetic field is applied to a sample to magnetize it. The sample is connected to a drive-head that vibrates the sample at 60 Hz. This creates a magnetic field that varies spatiotemporally which induces a current in a set of pick-up coils that is proportional to the induced magnetization of the sample.

Using magnetization data, one can also estimate the volume fraction of the ribbon that has crystallized by utilizing Brillouin function fitting. The functions simplify for spin-only dipole moments to the form:

$$M = tanh \frac{M}{T / {T}_{C}} \qquad ( 9 )$$

where M is the magnetization and T is the temperature. Brillouin functions can be used to extrapolate the magnetization curve to 0 K. If the specific magnetization of the crystalline phase is known, then the fraction of the sample that is crystalline can be determined. The amorphous phase typically has a T_{C} that is lower than the temperature for primary crystallization, Tₓ₁. Therefore, the magnetization goes to zero at the T_{C} of the amorphous phase for an as-cast ribbon. When Tₓ₁ is reached, the magnetization increases as a function of the volume fraction transformed. After crystallization, the sample is cooled and the amorphous phase again contributes to the magnetization. By fitting a Brillouin function to the crystalline phase, the magnetization resulting from the presence of the crystallites is determined. By comparing this value to the specific magnetization of the crystallites, the mass percentage of the crystalline phase can be calculated. This technique has been demonstrated in a recent publication.

As mentioned earlier, XRD is used to ensure the amorphousness of the as-cast ribbon, but is also used to check the phase transformation that occurs upon annealing. X-ray diffractometers fundamentally rely on Bragg's Law:

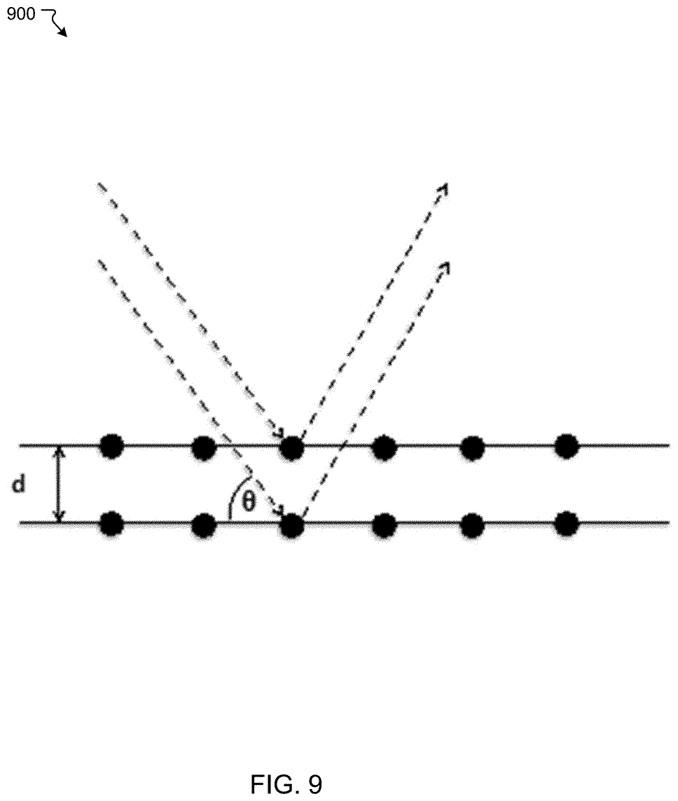

nλ=2d sin(θ) (10)

where n is an integer, λ is the x-ray wavelength, d is the atomic lattice interplanar spacing, and θ is the angle between the x-rays and the atomic plane, as show in diagram 900 of FIG. 9. Conventional XRD equipment uses a single λ and varies the θ value. At the Advanced Photon Source, there is access to energy dispersive XRD which uses a range of wavelengths and has a fixed θ value.

With XRD crystallite size after crystallization can also be estimated using a Scherrer analysis. The diffraction peaks are first fit with a Gaussian curve. For a Gaussian, the width of the peak is related to the integral breadth by:

β=w\sqrt{π} (11)

where β is the integral breadth and w is the width. Instrumental broadening is then removed from the peak integral breadth via quadratic subtraction. The resulting integral breadth can be attributed to crystal size. The calculated integral breadth βₛ is used to estimate the crystal size using the Scherrer equation:

$$d = \frac{K λ}{{β}_{s} cos θ} \qquad ( 12 )$$

where d is the average grain size and K is a shape factor typically between 0.9 and 1. In general, the as-cast materials are expected to have primarily just a broad amorphous halo. The materials that have undergone primary crystallization should have a much-reduced amorphous halo, but the crystalline peaks will still be broad due to the small crystallite sizes.

The materials can also be strain annealed, which has multiple effects. From DSC, the primary and secondary crystallization temperatures are determined. Then the as-cast ribbons are strain annealed between the two temperatures. The ribbons are annealed in a tube furnace with atmospheric conditions. This creates a nanocomposite, which improves the magnetic inductance of the foil. In addition, varying the stress applied during annealing allows us to tune the permeability of the ribbon. After strain annealing, XRD data is collected to confirm crystallization, and magnetic data is collected to confirm the effects of strain annealing. Strain annealing is also used to demonstrate the superplasticity of the amorphous phase. Superplasticity can simply be defined as the ability of a material to undergo significant plastic deformation in tension without rupture. A metallic glass above its T_{g} becomes a viscous supercooled liquid capable of viscous flow. The viscosity between T_{g} and crystallization can change by 7 orders of magnitude. These supercooled liquids can experience significant plastic strain under an applied stress. The processing is similar to that for thermoplastics, where formability is temperature dependent. The primary difference being that an amorphous glass is metastable, so the superplastic forming region in this system is likely to be limited by the secondary crystallization temperature. Measuring the elongation is accomplished by marking the ribbon with a high temperature marker before strain annealing, and measuring how far the marks move after the sample is annealed. Example results show a nearly 100% elongation for an (Fe₆₀Ni₄₀)₈₀Nb₄Si₂B₁₄ sample.

Experimental Results:

DSC:

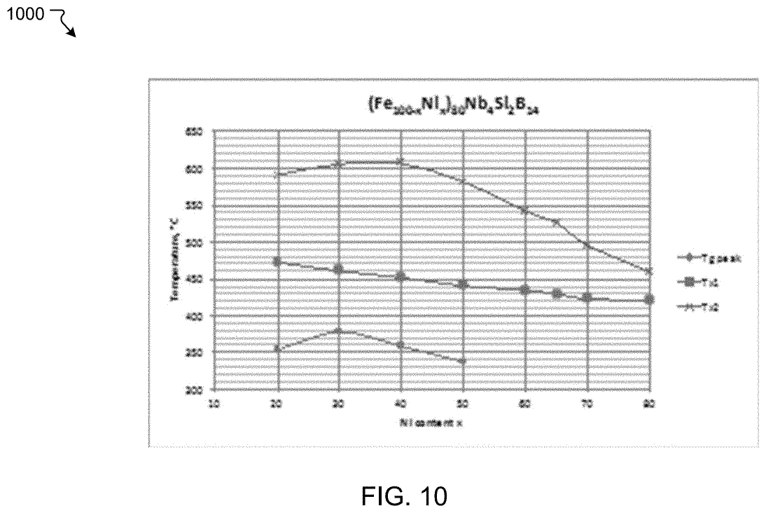

DSC curves have been collected for a large range of Fe—Ni compositions with glass transition (T_{g}), primary crystallization (Tₓ₁), and secondary crystallization (Tₓ₂) temperatures measured. T_{g} is important because these alloys are brittle at room temperature after primary crystallization. Above T_{g}, it will be possible to stamp them into shape for use as a motor stator. In addition, it is important to know the temperature range between Tₓ₁ and Tₓ₂ in order to know the maximum temperature the material can tolerate before irreparable properties damage. These results can be seen in graph 1000 of FIG. 10.

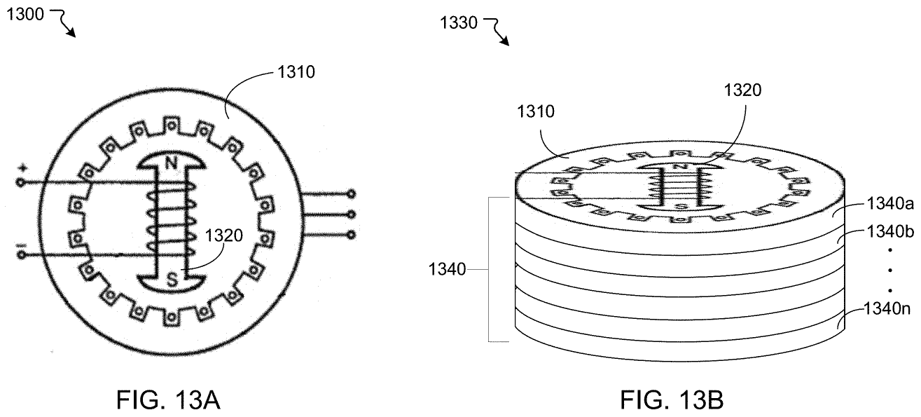

Superplastic formability distinguishes certain metallic glasses from other metals by allowing them to be shaped and processes similarly to thermoplastics. Once stamped, many layers can be stacked to build the component. FIG. 13A shows an example of an electric motor 1300 from above. A stator 1310 that includes the nanocomposite (e.g., nanocomposite 100 of FIG. 1) and a rotor 1320 are shown. FIG. 13B shows an example of an electric motor 1330 from a side-perspective view. The stator 1310 is constructed from a stack 1340 of nanocomposite layers 1340a-n. As stated above, the layers 1340a-n each have thicknesses of less than 30 μm to reduce losses during high-frequency operations. The stack 1340 of the layers of the nanocomposite is a cheaper manufacturing method than laser cutting which would have to be used otherwise.

VSM:

In diagram 800 of FIG. 8 it is shown how the saturation induction in Fe—Ni alloys depends on Ni content. The induction increases with higher Fe content as expected from the Slater-Pauling curve. The data in diagram 800 of FIG. 8 is for as-cast samples. Toward the Ni-rich end, the Ms begins to get lower than desired for applications. It is expected that the Ms of the materials after primary crystallization will be higher as compared to the amorphous.

In addition, an M vs. T curve has been collected for an example (Fe₇₀Ni₃₀)₈₀Nb₄Si₂B₁₄ alloy as seen in diagram 1000 of FIG. 10. It would normally be expected the magnetization to increase as temperature is decreased, but it can be seen that eventually the magnetization begins to decrease with temperature. This can be explained as a spin glass phenomenon. As the temperature is cooled below the ferromagnetic→asperomagnetic transition, the spins are frozen in such a way that they are canted with respect to each other, but all canting angles within a hemisphere. Upon heating, the asperomagnetic phase is metastable, and the magnetization approaches the cooling curve as the temperature approaches room temperature. Canted spins diminish the usable magnetization in motor applications. Due to the T-dependence this is more of a concern for cryomotor applications.

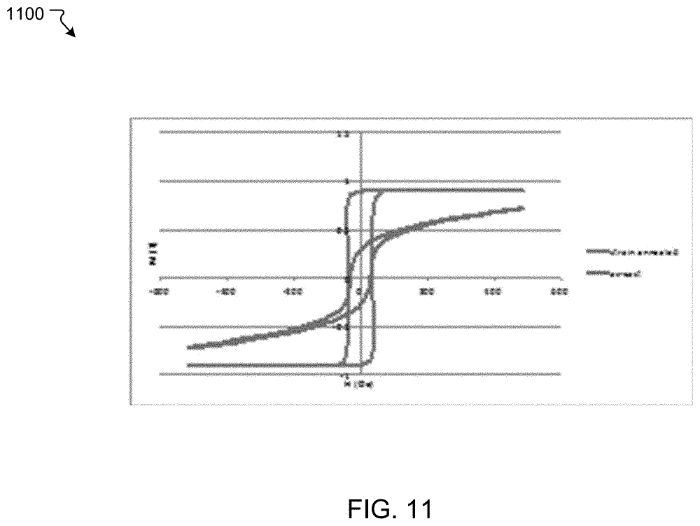

Diagram 1100 of FIG. 11 shows M vs. H curves for the (Fe₇₀Ni₃₀)₈₀Nb₄Si₂B₁₄ sample as-cast and strain annealed at 200 MPa and 470° C. The permeability for the strain-annealed sample is nearly an order of magnitude higher than for the as-cast. We have demonstrated an increase of permeability from 4,000 to 16,000. It is expected that Ni-rich ribbons will have the opposite effect due to opposite sign of the magnetostriction coefficients. M vs. H data has been collected for several other Fe-rich alloys as-cast and strain annealed. The other alloys all show an increase in permeability with strain annealing.

XRD:

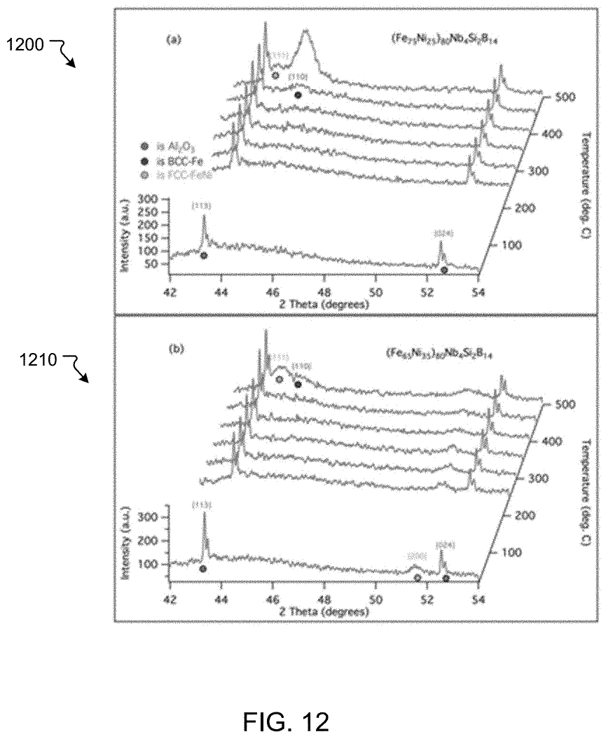

High temperature XRD (HTXRD) was done on an as-cast (Fe₆₅Ni₃₅)₈₀Nb₄Si₂B₁₄ alloy, shown in graph 1200 of FIG. 12. The peaks are matched in CrystalDiffract using crystal models. The peaks from the corundum background are marked with orange, while the FCC peaks are marked with green, and the BCC peak is marked with blue. The corundum peaks are doubled due to the presence of Cu Kα1 and Kα2 radiation. As can be seen, the ribbon starts off primarily amorphous, but with a noticeable broad FCC {002} peak. By 500° C., primary crystallization occurs, and both FCC and BCC peaks can be seen. From prior work, it is expected that further heating above the Fe α→γ transition temperature will convert the α-Fe to γ-Fe, and that it will not transform back upon cooling. It is also possible to determine the phase fraction of the crystallites and the amorphous matrix by fitting Gaussian curves or pseudo-Voigt curves to the peaks. The ratio of the peak areas then provides the phase fractions. Values for a (Fe₇₅Ni₂₅)₈₀Nb₄Si₂B₁₄ base alloy are shown in graph 1210 of FIG. 12.

Virtual Bound States (VBS) and Resistivity:

VBS theory describes a dilute transition element (TE) d-electron as it moves through the Fermi energy of a parent alloy comprised of late transition metals (TL) and is added to empty spin states. Each TE atom will make a contribution to the empty TL 3d states. The TE atoms generate perturbing energy wells that scatter conduction electrons, thereby raising the resistivity.

Vanadium was added to (Fe₇₀Ni₃₀)₈₀Nb₄Si₂B₁₄ base alloy, and resistivity was measured, with the V amount ranging from 0.5%-5% at the expense of (FeNi). It was found that adding V can increase the resistivity by ˜40% without a significant worsening of magnetic properties.

Cu Additions:

DSC can provide activation energy for crystallization and the Avrami exponent. The base (Fe₇₀Ni₃₀)₈₀Nb₄Si₂B₁₄ alloy has an Avrami exponent of 2.5, which corresponds to continuous nucleation and 3-dimentional crystal growth. An (Fe₇₀Ni₃₀)₇₉Nb₄Si₂B₁₄Cu₁ alloy however, has an Avrami exponent of 1.5, which corresponds to instantaneous nucleation and 3-dimention growth. This provides a finer crystal structure which will further reduce the losses.

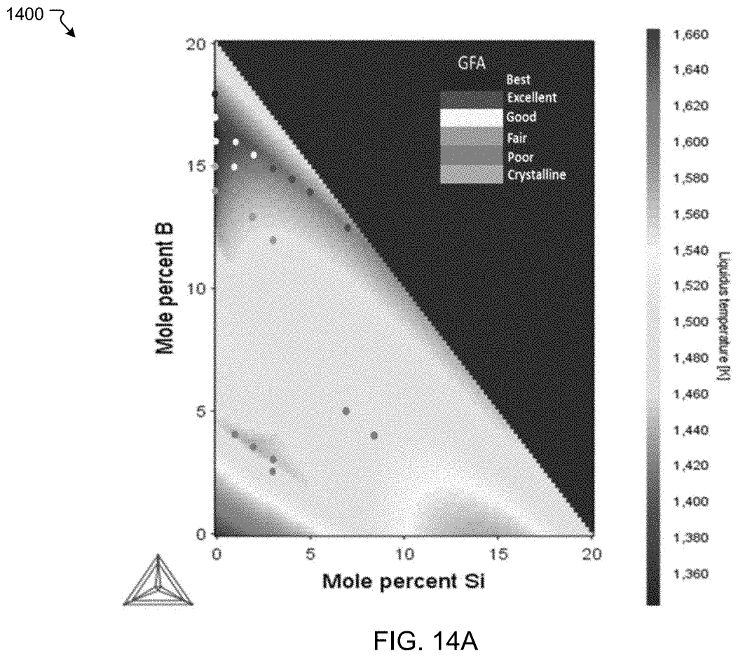

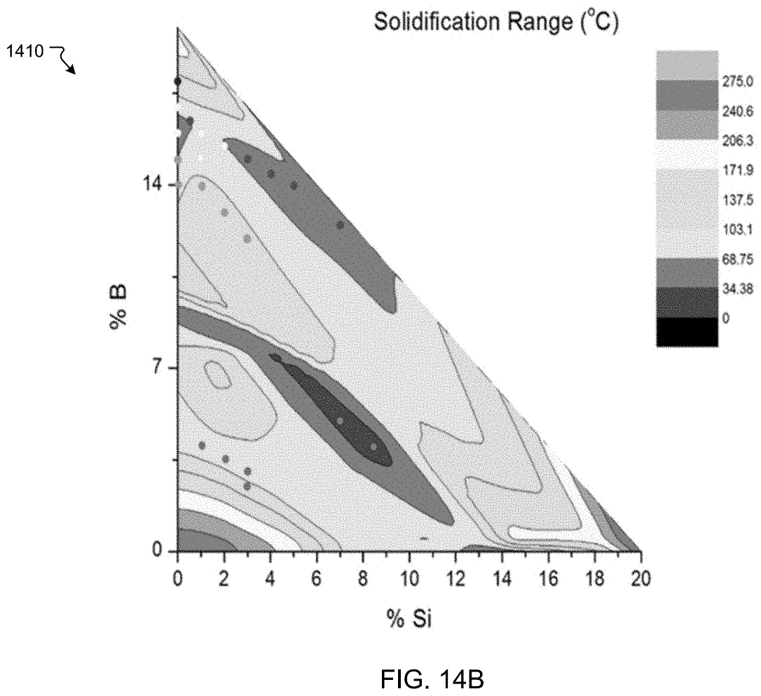

Turning to FIGS. 14A-14B, simulation results of glass forming ability (GFA) for various compositions of materials are shown. As previously described, metal amorphous nanocomposities (MANCs) are soft magnetic materials that consist of nanocrystalline grains surrounded by an amorphous matrix. They combine higher saturation inductions than amorphous metal ribbons (AMR) with lower coercivities and higher electrical resistivities than crystalline materials, leading to lower hysteresis and eddy current losses. MANCs are produced by planar flow casting, in the form of amorphous ribbon, and then annealed to induce crystallization. Due to the amorphous precursor to the nanocrystalline state the glass forming ability (GFA) is critical to alloy development. Typically, magnetic induction is sacrificed for glass forming ability (and resistivity) in AMR and MANC alloys as compared with crystalline materials (e.g. Si steels) because the addition of glass forming elements degrades these properties. Optimization of GFA enables reduced glass former content and better performance. Advances in MANC alloys in which the amorphous phase has higher GFA values impacts the formability of such materials in applications such as hot stamping motor laminates (e.g., for motors described in relation to FIGS. 13A-13B).

GFA is defined by the minimum cooling rate (Rc) necessary to form an amorphous material. Rc is difficult to measure experimentally, so several parameters have been developed to rank GFA of amorphous materials. Glass forming alloys are designed following three empirical guidelines. First, the material generally includes at least 3 atomic species. Second, the material includes 12% or more difference in the size of the atoms. Third, there is negative enthalpy of mixing of the elements in the liquid phase. The first two rules are also attributed to the “confusion principle,” in which the additional complexity of the alloy and atomic size difference complicates and slows kinetics of crystallization, increasing the probability of an amorphous phase forming. In addition to the slowed kinetics, multiple atomic species also reduce the free energy advantage of forming a crystalline phase. As one forms alloys with four or more components, equilibrium structures can have very large unit cells. The long-range order of these phases makes the free energy reduction (relative to the liquid) from crystallization minimal. The third rule is based on the need to prevent the elements from unmixing in the liquid.

Models that are based on atomic size difference have been proposed to explain and predict GFA, based on maximizing density of the liquid and resulting amorphous phase. Increasing the amorphous phase density reduces driving force for crystallization. Generally, alloys with the smallest volume change upon solidification, and therefore higher density in the liquid, have the best GFA. High density in the liquid phase results in higher viscosity, and less free volume in the super-cooled liquid, both of which reduce the rate of diffusion and slow kinetics of crystallization. Such models predict necessary concentrations of alloying elements based on atomic size in binary and ternary alloys but become excessively complex in higher order systems. Another model is the maximum possible amorphization range (MPAR) model, which correlates GFA of an alloy system to the composition range between the maximum solid solubilities in a eutectic. This, too, is impractical beyond ternary alloys.

Kinetics-based predictions of GFA are also possible. Alloys with high viscosities tend to have improved GFA, because high viscosity results in lower diffusion rates and slows nucleation and growth of the crystalline phase. The effect of additional alloying elements on GFA depends strongly on the viscosity of the element in the liquid state. However, viscosity is difficult to measure, and cannot be readily used to predict GFA.

As seen above, theories based on the three empirical rules, as well as kinetics, fail to predict GFA or serve as more than relative guidelines in alloy development. Additionally, exceptions exist for all proposed rules, due to the significant difference in metallic glass structures, indicating that many possible alloys are not being identified. The ability to sample a large composition space and identify good glass formers would be very advantageous for alloy development.

Additionally, compositions near or at eutectics have good GFA. In a eutectic alloy, the liquid phase is stable down to a lower temperature, at which viscosity increases, slowing diffusion and making the amorphous structure form more readily. In addition, the material crystallizes at equilibrium into two phases, resulting in the need for alloying elements to partition between phases and slowing crystallization kinetics.

Based on the idea of improving GFA by locating eutectic compositions, thermodynamic calculations can be used to locate minima in liquidus temperatures for a range of compositions.

Soft magnetic alloys have several significant differences from other amorphous alloys. Most amorphous alloys are bulk metallic glasses (BMGs) having very high percentages (>40%) alloying elements, which allow them to remain amorphous at low cooling rates. In contrast, magnetic alloys have typically less than 30% alloying elements, with the goal being to reduce this as much as possible. Lower alloying additions improves saturation magnetization and reduces coercivity by increasing magnetic element content. Soft magnetic alloys therefore fall into the category of marginal glass formers, or alloys that require rapid solidification techniques to produce. This is generally not a significant problem, since the thin material produced by rapid solidification is ideal for reducing eddy current loss. However, the alloy must have sufficient GFA to remain amorphous at cooling rates achievable by rapid solidification.

The previously mentioned method was applied to rapidly identify compositions with good GFA in an (Fe₇₀Ni₃₀)₈₀(B—Si—Nb)₂₀ soft magnetic alloy system. This system is explored as described below using a combination of thermodynamic modeling and experimental validation. Thermocalc simulation was used to identify regions showing minima in liquidus temperature and solidification range by varying Nb, Si, and B over the entire range levels as high as 20%. Additionally, since one goal of increasing GFA in soft magnetic alloys is to allow for greater percentages of magnetic elements, the simulation was repeated for alloys with lower concentrations of glass formers.

Additionally, it is advantageous for power magnetic applications for the ribbon to be processable into laminates by hot stamping forming, and for the ribbon thickness and material structure and anisotropy to be controlled through rolling proccesses. Hot forming of amorphous material can be performed by blow molding. Alternatively, forming can be performed by pressing into dies at high temperatures. Compatibility with such processes can be determined by analyzing the temperature range between glass transition and crystallization temperatures, with preferred alloy systems displaying a value of T_{g} significantly below Tₓ to allow for a window of suitable processing temperatures. Below T_{g}, the material is unable to deform, while above it the material can exhibit viscous flow. Above Tx, crystallization will impede further deformation although in some compositions it may be possible to retain hot formability during or after the crystallization stage through a Tg of the intergranular amorphous precursors below the processing temperature of interest. For this reason, the effect of concentration of the three glass formers on these temperatures are measured.

Selected Composition Based on Modeling

Results of the Thermocalc simulations for liquidus temperature and solidification range are shown in FIGS. 14A and 14B, as shown in graph 1400 and graph 1410, respectively. Graph 1400 shows liquidus temperature for various compositions. Graph 1410 shows solidification ranges for various compositions. GRA rankings are represented by shaded dots. A minimum in both liquidus and solidification range was identified from 0-7% Si, 14-18% B, and 0-6% Nb, and was found to have the best GFA, and are considered exemplary embodiments, shown in graph 1400. GFA was ranked by the parameter T_{rg}=(T_{g}/Tₗ), and the temperature range ΔT_{xg}=(Tₓ−T_{g}) was measured. As mentioned previously, alloys with large and positive ΔT_{xg} are promising for hot forming applications because they have a larger temperature range in which they can be thermomechanically formed but tend to have lower GFA according to T_{rg}. Nevertheless, several exemplary alloys have been identified in this composition range that have both good GFA and large ΔT_{xg}. T_{rg}, GFA ranking, and ΔT_{xg} as shown in Table 1, below.

Table 1 Shows T_{rg}, Used to Measure GFA, and the Relative Ranking of Tested Compositions, as Well as ΔT_{Xg}

| | | | | | | Rank |
|---|---|---|---|---|---|---|
| Composition | T_{g} | Tₓ | Tₗ | T_{rg} | ΔT_{xg} | by T_{rg} |
| (Fe₇₀Ni₃₀)₈₀B₁₈Si₀Nb₂ | 422 | 470 | 1107 | 0.381 | 48 | 1 |
| (Fe₇₀Ni₃₀)₈₀B₁₄Si₅Nb₁ | 415 | 485 | 1109 | 0.374 | 70 | 2 |
| (Fe₇₀Ni₃₀)₈₀B_{12.5}Si₇Nb_{0.5} | 413 | 480 | 1112 | 0.371 | 67 | 3 |
| (Fe₇₀Ni₃₀)₈₀B_{14.5}Si₄Nb_{1.5} | 404 | 477 | 1107 | 0.364 | 73 | 4 |
| (Fe₇₀Ni₃₀)₈₀B_{16.5}Si_{0.5}Nb₃ | 400 | 462 | 1106 | 0.361 | 62 | 5 |
| (Fe₇₀Ni₃₀)₈₀B₁₅Si₃Nb₂ | 398 | 478 | 1102 | 0.361 | 80 | 6 |
| (Fe₇₀Ni₃₀)₈₀B₁₇Si₀Nb₃ | 400 | 465 | 1108 | 0.361 | 65 | 7 |
| (Fe₇₀Ni₃₀)₈₀B₁₆Si₁Nb₃ | 392 | 467 | 1103 | 0.355 | 75 | 8 |
| (Fe₇₀Ni₃₀)₈₀B_{15.5}Si₂Nb_{2.5} | 393 | 471 | 1109 | 0.354 | 78 | 9 |
| (Fe₇₀Ni₃₀)₈₀B₁₆Si₀Nb₄ | 370 | 461 | 1094 | 0.338 | 91 | 10 |
| (Fe₇₀Ni₃₀)₈₀B₁₅Si₁Nb₄ | 358 | 458 | 1166 | 0.307 | 100 | 11 |
| (Fe₇₀Ni₃₀)₈₀B₁₅Si₀Nb₅ | 339 | 465 | 1176 | 0.288 | 126 | 12 |
| (Fe₇₀Ni₃₀)₈₀B₁₄Si₁Nb₅ | 341 | 498 | 1192 | 0.286 | 157 | 13 |
| (Fe₇₀Ni₃₀)₈₀B₁₃Si₂Nb₅ | 318 | 475 | 1193 | 0.266 | 157 | 14 |
| (Fe₇₀Ni₃₀)₈₀B₁₂Si₃Nb₅ | 314 | 497 | 1197 | 0.262 | 183 | 15 |
| (Fe₇₀Ni₃₀)₈₀B₁₄Si₀Nb₆ | 307 | 470 | 1205 | 0.254 | 163 | 16 |
| (Fe₇₀Ni₃₀)₈₀B₄Si_{8.5}Nb_{7.5} | 302 | 430 | 1225 | 0.246 | 128 | 17 |
| (Fe₇₀Ni₃₀)₈₀B₅Si₇Nb₈ | 294 | 470 | 1235 | 0.238 | 163 | 18 |

Advanced Manufacturing Processes Leveraging Large ΔT_{xg} Alloys

A unique advantage of alloys with large and positive values of ΔT_{xg} is the compatibility with advanced manufacturing processes including stamping, forming, rolling, and related processes which can be used to alter the laminate shape, ribbon thickness, material anisotropy, and structure in ways that would otherwise not be possible for existing prior art MANC alloy systems. Some example embodiments are described below for advanced manufacturing processes which are enabled through this unique alloy property along with potential applications and end-use component performance benefits.

Hot Stamping Processes

Laminate stamping is an established process for crystalline soft magnetic alloys used in transformer and motor applications. However, the application to amorphous alloys at manufacturing scale has been severely limited by the exceedingly hard mechanical properties of rapidly solidified ribbons, which tend to cause high wear of stamping dies. Amorphous alloys with relatively low values of T_{g} below the crystallization temperature (i.e. high ΔT_{xg}) offer the potential for elevated temperature stamping processes above Tg but below the crystallization temperature where the alloys are easily deformable to avoid high wear rates of stamping dies and tooling. Stamped laminates can then be subjected to post stamping annealing treatments to optimize microstructure and magnetic properties.

Hot Rolling Processes:

Although rolling is a standard process in the optimization of soft magnetic crystalline alloys at scale, application to amorphous alloys has also been limited by the mechanical properties of amorphous soft magnetic ferromagnets. A particularly attractive aspect of the application of rolling processes to amorphous and MANC alloy systems for soft magnetic applications, is the potential for a significant reduction in eddy current losses with reduction in ribbon thickness without adversely impacting overall ribbon quality and continuity. Thickness reductions through rapid solidification processing adjustments are limited to ˜10-15 microns due to the formation of pinholes and other ribbon defects during the casting process as the ribbon thickness is reduced, thereby limiting frequency performance to an upper limit of ˜100 kHz. Rolling processes to further reduce the thickness of cast ribbons offer the potential to further reduce eddy current losses and increase the maximum operational frequency of this class of rapidly solidified alloys.

In addition to thickness reductions, rolling may allow new anisotropy mechanisms to be accessed including crystallographic texture, slip-induced anisotropy, and others. Alloys with a high ΔT_{xg} are uniquely suited for hot rolling applications at temperatures between T_{g} and Tₓ where viscous flow will be activated without crystallization to ensure successful thickness reductions without ribbon breakages or defects. Subsequent thermal treatments can then be applied to the ribbons to optimize magnetic properties. In some cases, engineered MANC alloys for which the intergranular amorphous phase retains a sufficiently low T_{g} may be compatible with hot-rolling processes without requiring a two-step or multi-step process scheme that reduces thickness prior to the partial devitrification to optimize magnetic properties. In some cases hot rolling combined with, or following the crystallization process may enable accessing unique induced anisotropy mechanisms through controlling the shape, crystallographic texture, bond orientation configuration, and defect structure of embedded nanocrystals.

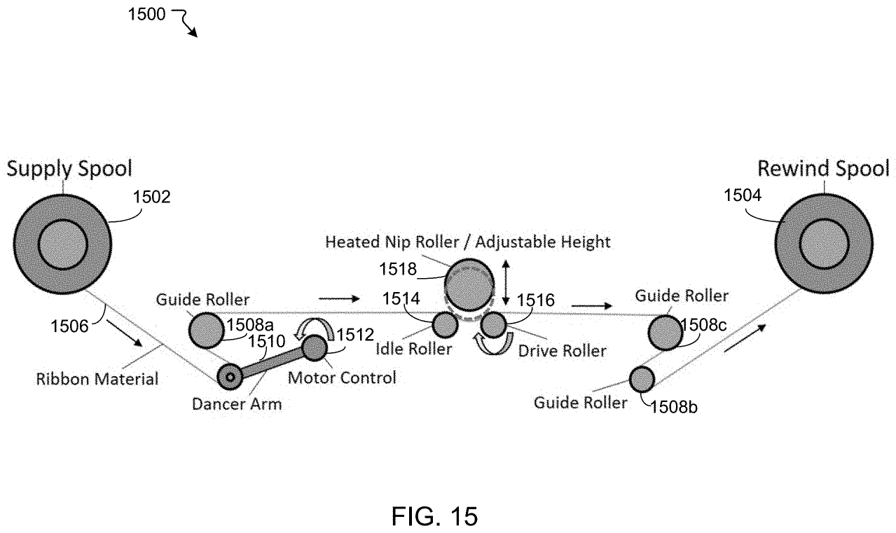

FIG. 15 shows a schematic of hot rolling mill system 1500 where the drive-heated nip rollers pull the material off the dancer unwind and rewind onto a slip clutch rewind. The height-adjustable heated nip roller 1518 is supplied with pneumatic pressure to contact and feed the strip 1506 through the roll assembly. The system 1500 includes a supply spool 1502 and a rewind spool 1504. A ribbon material 1506 is fed through the system 1500. The ribbon material 1506 is fed over a dancer arm 1510 that is moved by a motor control 1512. The ribbon material 1506 moves through a guide roller 1508a to the heated nip roller 1518, which can be adjusted in height. The heated nip roller presses the ribbon material 1506 onto an idle roller 1514 and across a drive roller 1516. The ribbon material 1506, now annealed, then is guided through guide rollers 1508b and 1508c and to the rewind spool 1504.

Induction Rolling Processes/Roll Bonding Processes:

In some implementations, it may be desired to avoid direct heating of the rolls which requires a large thermal mass and specially engineered rolls which retain mechanical properties and avoid oxidation during long-term operation for hot rolling processes. An alternative processing approach involves inductive heating of the material under process directly through applying an RF electromagnetic potential across the rolls which then induces highly localized eddy current losses and associated heating within the strip material. In this way, exceedingly rapid heating rates can be achieved within the ribbon in conjunction with the application of mechanical stresses due to the presence of the rolls. This alternative processing scheme does not require the rolls to be provided with continuous thermal excitation or to remain at a constant elevated operational temperature thereby reducing wear, oxidation, and deterioration in mechanical properties and making the process scalable and capable of manufacture.

Localized induction annealing also provides advantages in terms of further optimizing the thermal treatments, which can be advantageous given optimized microstructures which have been attained in other MANC compositions having large associated saturation inductions through rapid thermal annealing procedures. In addition to hot rolling of the rapidly solidified metallic strip materials, more advanced processes can also be considered including roll bonding with other metals to optimize mechanical, electrical, and/or magnetic properties. For example, roll-bonding with thin Al-foils or other oxidizable metals followed by subsequent oxidation stages during the thermal anneal to produce an optimize MANC microstructure can potentially increase stack resistance and reduce associated eddy current losses to increase maximum operational temperature of performance.

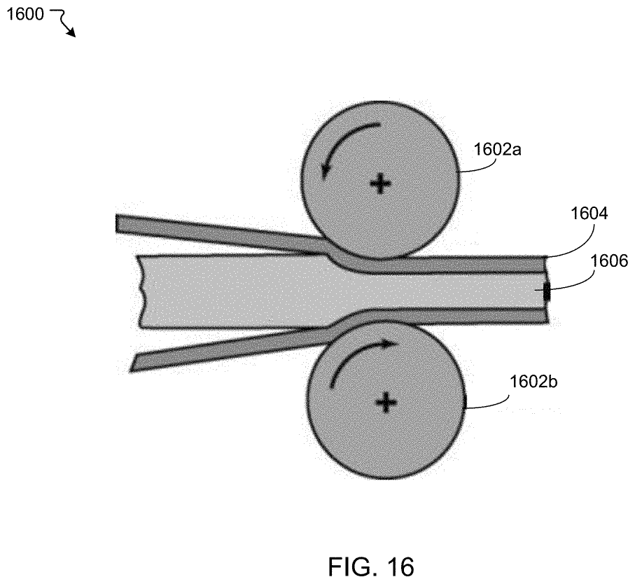

Turning to FIG. 16, an example roll-bonding system 1600 is shown. The rollers 1602a and 1602b can be directly heated thermally, or an applied RF potential across the rollers can be applied to produce inductive heating in the base metal 1606 and the cladding material 1604 through eddy currents.

Hot Forming and Blow Molding Processes:

Forming of traditional soft magnetic crystalline alloys is a significant challenge due to the deterioration in magnetic properties that result from mechanical forming as ideal microstructures exhibit large grains with a minimum of defects to avoid domain wall pinning and associated magnetic losses. Forming of amorphous alloys above the glass transition temperature is an advantage that has been exploited in a number of structural material applications such as bulk metallic glasses. However, forming processes have not been previously exploited in soft magnetic amorphous alloys due to the crystallization at temperatures where formability is enhanced through viscous flow above T_{g}. The newly developed MANC alloys described previously provide opportunities for the forming and blow molding of soft magnetic alloys with high ΔT_{xg} and allow for subsequent crystallization processes to successfully optimize microstructure and magnetic properties for a desired end-shape.

Forming after Nanocrystallization

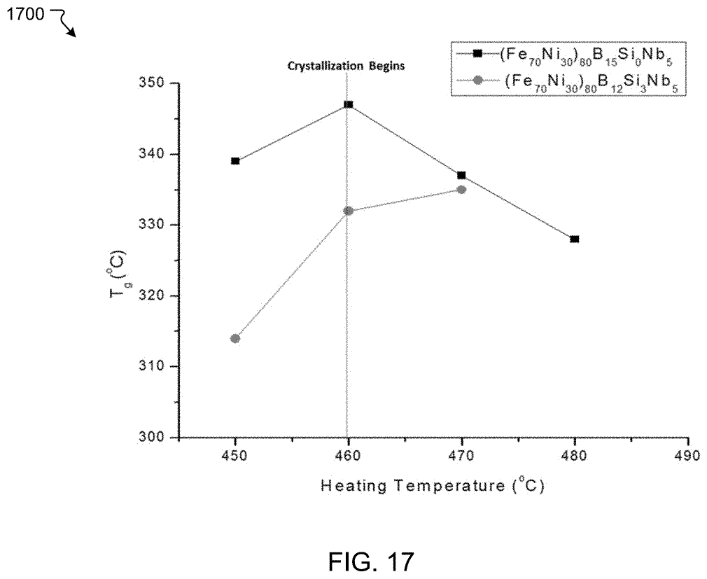

Since MANC materials have a residual amorphous phase, it is possible to apply the above processes to materials that have already been nanocrystallized. This would require a large ΔT_{xg} in the residual amorphous phase, since the crystalline grains are too small to undergo significant deformation. During the nanocrystallization process, glass-forming elements are expelled from the crystals into the residual amorphous matrix, changing its composition. The presence of a large ΔT_{xg} is therefore not apparent, even if it is large in the amorphous precursor. To confirm large ΔT_{xg}, samples of (Fe₇₀Ni₃₀)₈₀B₁₅S₁₀Nb₅ and (Fe₇₀Ni₃₀)₈₀Bi₁₂Si₃Nb₅ were crystallized to various degrees and Tg measured, as shown in graph 1700 of FIG. 17. Graph 1700 shows variation in T_{g} with annealing temperature, showing relatively small change in glass transition temperature with crystallization. While T_{g} was not discernable for fully crystallized samples, partially crystallized samples showed no significant change in T_{g}, while Tx does not change. This confirms a large ΔT_{xg} in crystallized samples.

Fe—Ni nanocomposites are a relatively unexplored alloy system that promises to be more affordable than Fe—Co alloys, and still have excellent soft magnetic properties. The alloys of the nanocomposite can be used for motor applications where maximum saturation magnetization is desired. It is also important to have a high enough Curie temperature and secondary crystallization temperature. The alloys of the nanocomposite are deformable above their glass transition temperatures, which allows for easy shaping into motor rotors or stators. These alloys have higher efficiencies at high frequencies than Si-steels commonly used in motors.

Other embodiments are within the scope and spirit of the description claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

It will thus be seen that the objects set forth above, among those made apparent from the preceding description, are efficiently attained and, because certain changes may be made in carrying out the above method and in the construction(s) set forth without departing from the spirit and scope of the disclosure, it is intended that all matter contained in the above description and shown in the accompanying drawings shall be interpreted as illustrative and not in a limiting sense.

A number of exemplary implementations of the nanocomposite have been described. Nevertheless, it will be understood by one of ordinary skill in the art that various modifications may be made without departing from the spirit and scope of the described embodiments.

What is claimed is:

1. A nanocomposite comprising:
crystalline grains in an amorphous matrix, the crystalline grains comprising an iron (Fe)-nickel (Ni) compound and being separated from one another by the amorphous matrix; and
one or more barriers between the crystalline grains and the amorphous matrix, the barriers being configured to inhibit growth of the crystalline grains during forming of the crystalline grains, a barrier of the one or more barriers being between a crystalline grain and the amorphous matrix;
wherein the amorphous matrix comprises an increased resistivity relative to a resistivity of the crystalline grains; and
wherein the amorphous matrix is configured to reduce losses of the crystalline grains caused by a change in a magnetic field applied to the crystalline grains relative to losses of the crystalline grains that occur without the amorphous matrix.

2. The nanocomposite of claim 1, wherein the crystalline grains comprise a Fe—Ni base that is meta-stable, face-center, and cubic.

3. The nanocomposite of claim 2, wherein the Fe—Ni base comprises γ-FeNi nanocrystals.

4. The nanocomposite of claim 1, wherein the barrier comprises niobium (Nb); and
wherein the amorphous matrix comprises boron (B) and silicon (Si) that together are configured to enable glass-forming ability of the amorphous matrix.

5. The nanocomposite of claim 1, further comprising a copper (Cu) nucleation agent configured to increase nucleation of the crystalline grains during a forming process relative to the nucleation of the crystalline grains during a forming process without the copper nucleation agent, and wherein the crystalline grains are reduced by more than 10% as a result of the increased nucleation.

6. The nanocomposite of claim 1, wherein a crystalline grain comprises an average diameter between 5-20 nm.

7. The nanocomposite of claim 1, wherein the nanocomposite forms a ribbon that is between 15-30 μm thick.

8. The nanocomposite of claim 7, wherein the nanocomposite comprises a magnetic anisotropy that is longitudinal along the ribbon.

9. The nanocomposite of claim 1, further comprising 50 atomic % or less of one or more metals comprising boron (B), carbon (C), phosphorous (P), silicon (Si), chromium (Cr), tantalum (Ta), niobium (Nb), vanadium (V), copper (Cu), aluminum (Al), molybdenum (Mo), manganese (Mn), tungsten (W), and zirconium (Zr).

10. The nanocomposite of claim 1, wherein the nanocomposite comprises 30 atomic % or less of cobalt (Co).

11. The nanocomposite of claim 1, wherein the nanocomposite comprises approximately 30 atomic % of Ni.

12. The nanocomposite of claim 1, wherein a resistivity of the crystalline grains is approximately 100 μΩ-cm and wherein a resistivity of the amorphous matrix is approximately 150 μΩ-cm.

13. The nanocomposite of claim 1, wherein the amorphous matrix is annealed to enable a superplastic response of the nanocomposite.

14. The nanocomposite of claim 1, wherein the crystalline grains in the amorphous matrix and the diffusion barriers comprise a strain-annealed structure that is tuned to a relative magnetic permeability above 10,000.

15. The nanocomposite of claim 1, wherein the change in a magnetic field applied to the crystalline grains occurs at a frequency between 400 Hz and 5 kHz.

16. The nanocomposite of claim 1, wherein the losses comprise eddy current losses.

17. A rotor laminate comprising:
one or more composite layers each comprising:
γ-FeNi nanocrystals in an amorphous matrix, the γ-FeNi nanocrystals having an average resistivity of less than 100 μΩ-cm and the amorphous matrix having a resistivity greater than 100 μΩ-cm; and
one or more boron diffusion barriers each between one or more of the γ-FeNi nanocrystals the amorphous matrix, each of the one or more diffusion barriers being configured to inhibit diffusional growth of the γ-FeNi nanocrystals during forming of the γ-FeNi nanocrystals;
wherein the γ-FeNi nanocrystals are approximately 70 atomic % Ni;
wherein an average diameter of the γ-FeNi nanocrystals is between 5 nm-30 nm; and
wherein the one or more composite layers are each less than approximately 25 μm thick.

18. The rotor laminate of claim 17, wherein composite layers each are strain-annealed composites comprising relative magnetic permeabilities above 10,000.

19. The rotor laminate of claim 17, wherein composite layers each further comprise copper.

20. An electric motor comprising:
a rotor; and
a stator configured to drive the rotor, the stator comprising a number of laminations that are less than 30 μm thick, each lamination comprising:
crystalline grains in an amorphous matrix, the crystalline grains comprising an iron (Fe)-nickel (Ni) compound and being separated from one another by the amorphous matrix; and
one or more barriers between the crystalline grains and the amorphous matrix, the barriers being configured to inhibit growth of the crystalline grains during forming of the crystalline grains, a barrier of the one or more barriers being between a crystalline grain and the amorphous matrix;
wherein the rotor is configured to operate at frequencies above 400 Hz.
